(19) United States
(12) Patent Application Publication
(10) Pub. No.: US 2007/0061868 A1
(43) Pub. Date: Mar. 15, 2007

(54) One-time password client

(75) Inventor: Uzi Dvir, Tel Aviv (IL)

Correspondence Address: DR. MARK FRIEDMAN LTD.;C/o Bill Polkinghorn, 9003 Florin Way, Upper Marlboro, MD, 20772, US

(73) Assignee: ALADDIN KNOWLEDGE SYSTEMS LTD.

(21) Appl. No.: 11/395,225

(22) Filed: Apr. 3, 2006

Related U.S. Application Data
(60) Provisional application No. 60/704,910, filed on Aug. 3, 2005.

(51) Int. Cl. H04L 9/32

(52) U.S. Cl. 726/2

(57) ABSTRACT

The present invention is directed to an OTP client, comprising: a plurality of tickets, each having an impression of a subsequent OTP value of an OTP sequence; and a ticket dispenser, for storing the tickets and for dispensing the tickets to a user for an authentication session. The OTP client may further comprise an impression of information for identifying the OTP sequence, such as a PIN associated with the OTP sequence. The OTP client may further comprise an amount indication mechanism, for indicating the number of tickets remaining in the dispenser, such as an aperture in the body of the dispenser, a sequential number impressed on the tickets, etc. According to one embodiment of the invention, the impression of an OTP value includes an impression of a barcode notation.

This is a continuation-in-part of U.S. Provisional Patent Application identified as U.S. 60/704,910 and filed on Aug. 03, 2005.

### FIELD OF THE INVENTION

The present invention relates to the field of one-time password authentication, including transaction authentication.

### BACKGROUND OF THE INVENTION

OTP, the acronym of One-Time Password, refers in the art to a password that can be used only once.

One-time password systems are designed to protect against “passive” attacks by preventing replay of passwords that have been seized by eavesdropping, e.g., on a network. OTP systems comprise two parties: an OTP server, and an OTP client, which is a device carried by a user and comprises a mechanism for generating OTP values (i.e., the one-time passwords), or memory for storing generated OTP values. OTP values are usually generated by pseudo-random algorithms, which are presently well known in the art. Each sequence is generated using a certain value (“secret”) known to the OTP server. The OTP client may either have a mechanism for generating OTP values which shares the same secret with a corresponding OTP server, or memory for storing M subsequent values of an OTP sequence. In the last case, the generated OTP values may be random values as well as pseudo-random numbers, since the values are stored at the OTP client, rather than generated.

In addition to the mechanism for generating or storing OTP values, an OTP client comprises means for providing the OTP values directly or indirectly to an OTP server. Indirect means may be, for example, a display which displays the current OTP value, and the user provides it to an OTP server by typing the password on a keyboard connected to the OTP server. Direct means may be, for example, a connection between the OTP client and the OTP server, such as a USB connection.

eToken NG, an OTP client manufactured by Aladdin Knowledge System Ltd., employs direct and indirect connection to an OTP server. This client can be connected to a USB port of the OTP server, and also comprises a display for showing the current OTP value. The eToken NG is manufactured in several form factors.

In order to implement a display in OTP client, the designer has to face some obstacles, such as a power source which must be available for years. This can be solved by components having low power consumption, long-life batteries, and so forth. In both cases it ends with relatively expensive components.

But even without implementing a display in an OTP client, OTP clients which implement electronics or computerized mechanisms are still a sophisticated mechanism, and as such designing and manufacturing OTP clients requires high skill and manufacturing abilities.

One type of OTP client which does not implement electronic or computerized components is known in the art as TAN, the acronym of Transaction Authentication Number. TANs are being used by some online banking institutions as a form of single use passwords to authorize financial transactions. A bank generates a set of unique TANs for a user, prints it on a sheet of paper as a list, and provides it to the user. In order to access a service, the user has to identify himself (e.g. by his ID number), and to present an unused TAN to the bank, e.g. by typing it on input means such as keyboard. The technique of scratching is also known, i.e. the printed TANS are covered with a scratch-able substrate. In order to use a TAN, the user has to expose the TAN by scratching the substrate that covers it. This way the user is also provided with information about which TANS have been used, and which are the still available.

It is an object of the present invention to provide an OTP client which may be relatively simple to manufacture.

It is another object of the present invention to provide an OTP client which employs relatively simple components.

It is a yet another object of the present invention to provide an OTP client which employs relatively cheap components.

It is a further object of the present invention to provide an OTP client which may be portable.

Other objects and advantages of the invention will become apparent as the description proceeds.

### SUMMARY OF THE INVENTION

In one aspect, the present invention is directed to an OTP client, comprising: a plurality of tickets, each having an impression of a subsequent OTP value of an OTP sequence; and a ticket dispenser, for storing the tickets and for dispensing the tickets to a user for an authentication session. The OTP client may further comprise an impression of information for identifying the OTP sequence, such as a PIN associated with the OTP sequence. The OTP client may further comprise an extracting mechanism, for extracting a ticket from the dispenser, such as an aperture on a facet of the dispenser. The OTP client may further comprise an amount indication mechanism, for indicating the number of tickets remaining in the dispenser. The amount mechanism may be, but is not limited to, an aperture in the body of the dispenser, a sequential number impressed on the tickets, etc. According to one embodiment of the invention, the impression of an OTP value includes an impression of a barcode notation. The OTP values may be presented also by one or more characters. The OTP client may further comprise an attaching mechanism, for attaching the OTP client to a key holder. According to one embodiment of the invention, the ticket dispenser comprises: a container for storing the tickets; one or more elastic members, for pushing the tickets to a facet of the container; and an aperture at the facet, for enabling a finger of a user to dispense the ticket.

In another aspect, the present invention is directed to an OTP system, comprising: an OTP server, for authenticating a user; an input device, for inputting an OTP value by the user to the OTP server; one or more OTP clients, each client comprising: a plurality of tickets, each having an impression of a subsequent value of an OTP sequence; and a ticket dispenser, for storing the tickets and for dispensing the tickets to the user in an authentication session. The input device may comprise: a keyboard, a virtual keyboard, a barcode reader, etc.

In yet another aspect, the present invention is directed to a system for producing OTP tickets, the system comprising: a generation mechanism, for generating a sequence of OTP values; and an impression mechanism, for impressing the sequence of OTP values on the tickets. According to one embodiment of the invention the generation mechanism is based on generating random numbers. According to another embodiment of the invention the generation mechanism is based on generating pseudo-random numbers. The impression mechanism may be, but not limited to, a printer, a text printer, a graphic printer, a barcode printer, etc.

In yet another aspect, the present invention is directed to a method for authenticating a user by an OTP server, the method comprising the steps of: providing to the user a plurality of tickets, each of which having an impression of a subsequent OTP value of an OTP sequence; providing by the user the OTP value impressed on the first of the tickets to the server; authenticating the user by comparing the information provided by the user to the system with information expected to be provided by the user to the system. The method may further comprise: providing by the user additional information to the server, such as of a multi-factor authentication nature, and a PIN. According to one embodiment of the invention the plurality of tickets are stored in a dispenser.

In yet another aspect, the present invention is directed to an OTP client, comprising: at least one display surface, such as a wheel or tickets, on which a plurality of subsequent OTP values of an OTP sequence are impressed; a housing (such a box), for housing the at least one display surface; and an exposure mechanism, for exposing the next subsequent OTP value of the OTP values to a user. The OTP client may further comprise an impression of information for relating a value of the OTP sequence to a corresponding OTP sequence, such as a PIN. The OTP client may further comprise an indication mechanism, for indicating the number of unused or used OTP values in the OTP client. The OTP client may further comprise attaching mechanism, for attaching the OTP client to another device, such as a loop. According to one embodiment of the invention the housing has a form factor of a credit card. The OTP may further comprise a supplementary mechanism, for performing a supplemental functionality in conjunction with the original functionality of the OTP client but without modifying the original operation of the OTP client such as a smartcard chip, a magnetic stripe, a figure, a branding area, a proximity coil, etc. The OTP client may further comprise a destruction mechanism, for destroying the impression of the OTP values under certain circumstances.

### BRIEF DESCRIPTION OF THE DRAWINGS

The present invention may be better understood in conjunction with the following figures:

FIG. 1 schematically illustrates an OTP client, according to a preferred embodiment of the invention.

FIG. 2 is a cross-section A-A of the dispenser of in FIG. 1.

FIG. 3 schematically illustrates an OTP client, according to another preferred embodiment of the invention.

FIG. 4 schematically illustrates an OTP client, according to another preferred embodiment of the invention.

FIG. 5 schematically illustrates an OTP system, according to a preferred embodiment of the invention.

FIG. 6 schematically illustrates a system for impressing OTP tickets, according to a preferred embodiment of the invention.

FIGS. 7a, 7b and 7c schematically illustrate an OTP client, according to another preferred embodiment of the invention.

FIGS. 8a and 9b schematically illustrate an OTP client, according to yet another preferred embodiment of the invention.

FIGS. 9a and 9b schematically illustrate an OTP client, according to yet still another preferred embodiment of the invention.

### DETAILED DESCRIPTION OF PREFERRED EMBODIMENTS

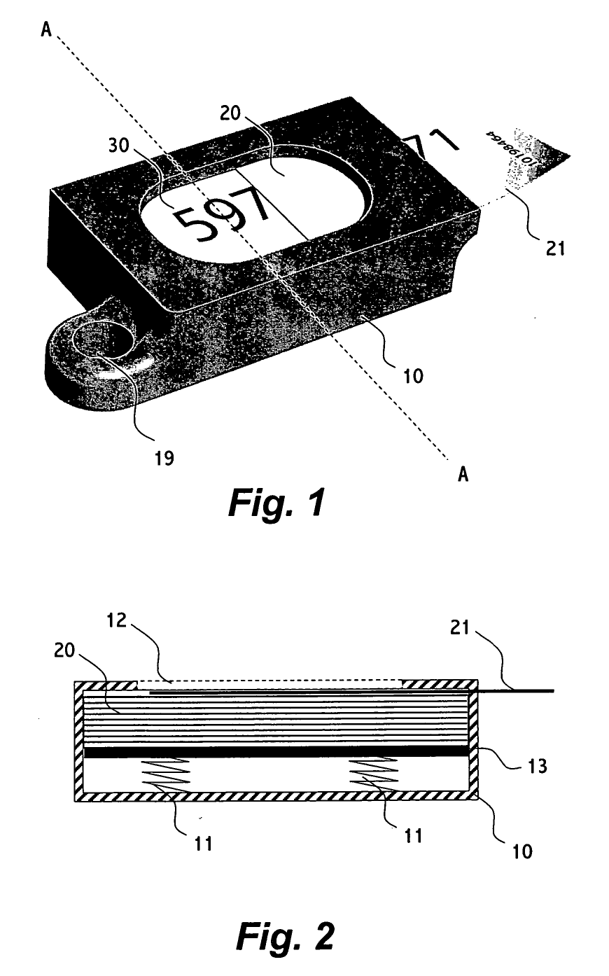

FIG. 1 schematically illustrates an OTP client, according to a preferred embodiment of the invention. The OTP client has the form factor of a dispenser. The dispenser comprises a case 10, and a plurality of tickets 20. On each of the tickets 20 is impressed an OTP value 30. In order to provide an OTP value to an OTP server (not shown), a user may type into a keyboard the value 30 which is impressed on the current ticket 21.

The user may push the current ticket 21 out of the case 10 using his thumb. In order to enable a connection between the user's thumb and the current ticket 21, the case 10 has an aperture 12 on the top of the case 12 (seen in FIG. 2).

Preferably the tickets are made of plain paper, but other materials can also be used, such as plastic and thermic paper.

FIG. 2 is a cross section A-A of the dispenser of in FIG. 1. It demonstrates the internal structure of the dispenser. One or more springs 11 generate force on the plate 13 on which the tickets 20 are placed. A magazine of a rifle is based on the same principle.

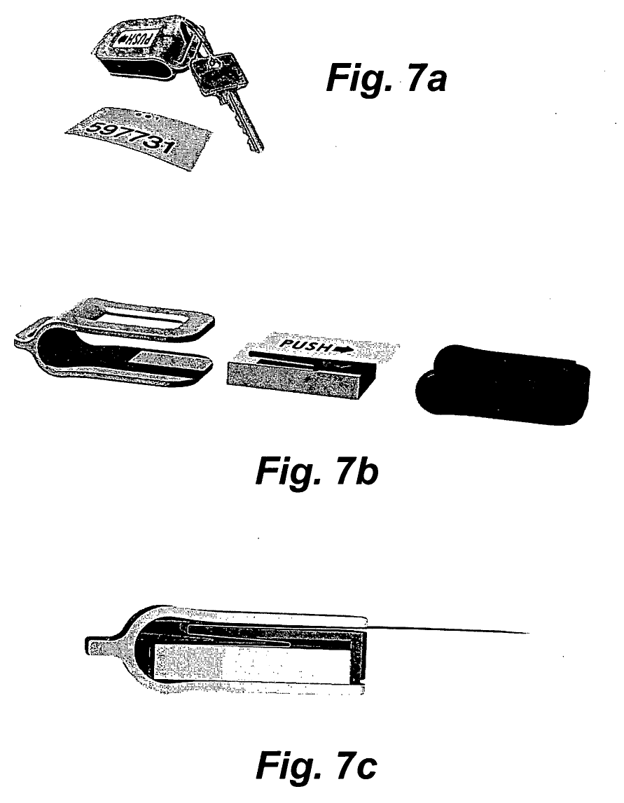

FIG. 7a schematically illustrates an OTP client, according to another preferred embodiment of the invention. FIG. 7b schematically illustrates its components, and FIG. 7c is a cross section of the OTP client. It should be noted that the tickets 20 are in a continuous form (i.e. adjacent tickets are connected).

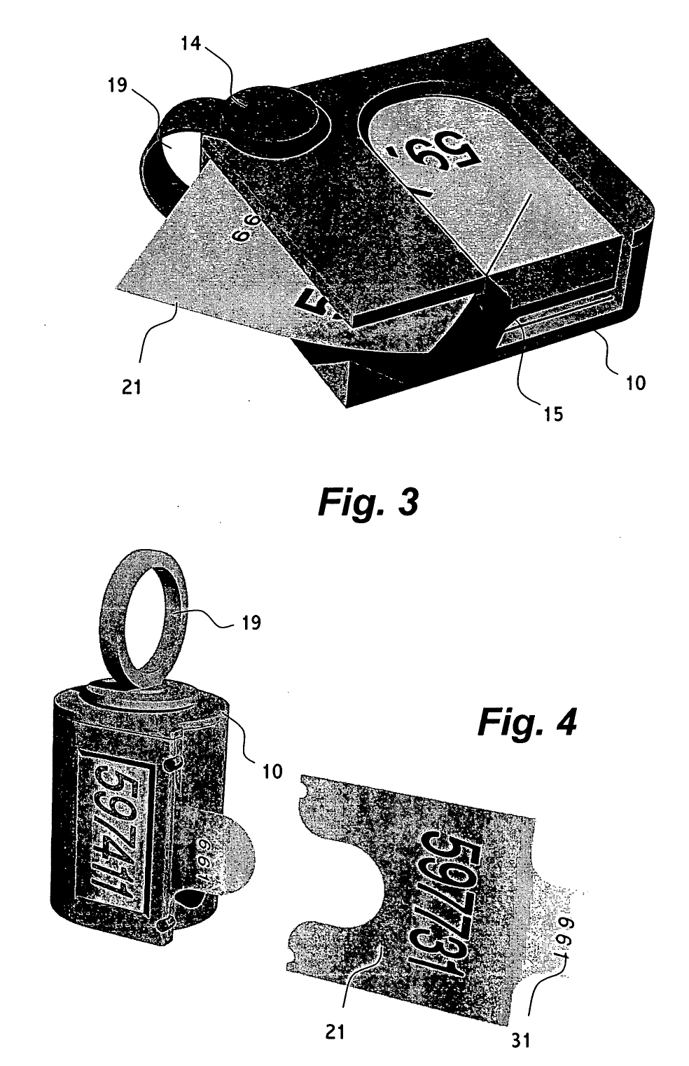

FIG. 3 schematically illustrates an OTP client, according to another preferred embodiment of the invention. The tickets are connected to the case 10 by an “axle” 14. An aperture 15 allows the upper ticket 21 to be pushed out from the dispenser 10 by a rotational movement. The advantage of the implementation of FIG. 3 over the implementation of FIG. 1 is that the side aperture in FIG. 3 enables a user thereof to estimate the amount of tickets left in the dispenser. In FIG. 1 this information should be printed on the tickets, otherwise the user has no knowledge of when the dispenser is exhausted. A loop 19 enables to connect the dispenser to a key holder.

FIG. 4 schematically illustrates an OTP client, according to another preferred embodiment of the invention. This type of dispenser is well known in the art. The value 16 denotes how many tickets remain in the dispenser.

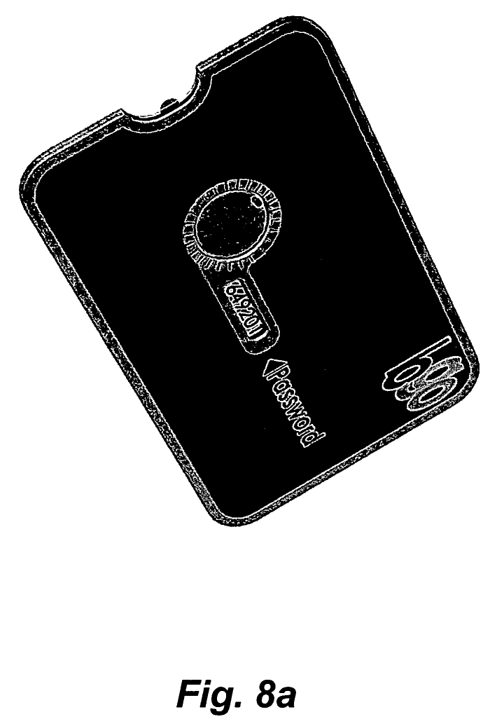

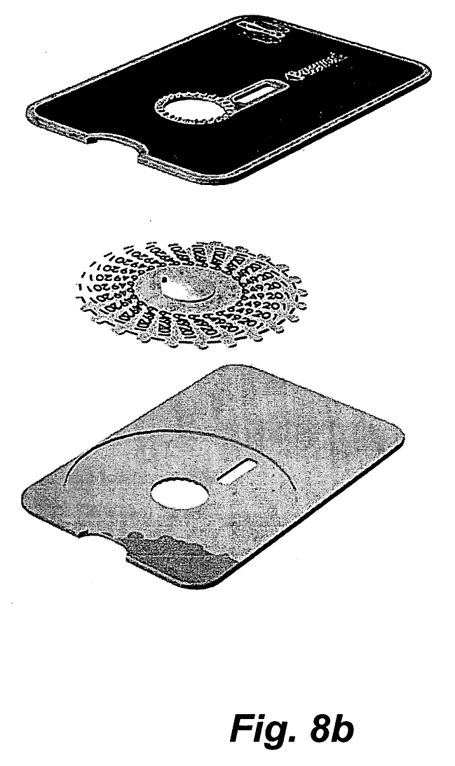

FIG. 8a schematically illustrates an OTP client, according to another preferred embodiment of the invention. FIG. 8b schematically illustrates components of the OTP client 50.

According to this embodiment the OTP client 50 is in form factor of a credit card (or business card, smart card, club card, etc.). A rotating wheel 52 on which the OTP values are impressed is enclosed between the top cover 51 and the bottom cover 53. According to one embodiment of the invention each impressed OTP value has an activation mechanism such as the dowel 54, by which the user thereof moves the wheel 52 until the next OTP value impression is seen through the aperture 56. The wheel 52 may have also a mark 57, which indicates how many unused OTP values are available in the wheel 52 (or how many OTP values have already been used). The impression 58 (on the cover 51) is of the number of used or available OTP values.

According to one embodiment of the invention, the OTP client 50 comprises a smartcard chip (not illustrated in the figures), and corresponding contacts for connecting the smartcard to a smartcard reader. This way a consolidation of two related activities is archived: a smartcard functionality, and OTP functionality. This allows embedding a second functionality in a device which performs a first functionality, for example: (a) embedding OTP functionality in a smartcard without modifying the application program that the smartcard executes; (b) embedding smartcard functionality within OTP functionality, without modifying the OTP functionality.

According to another embodiment of the invention the OTP client 50 comprises a magnetic stripe, for storing additional data. In this embodiment also a second functionality is embedded in a device which performs a first functionality. Other technologies that may be implemented for this purpose are proximity coil, a picture or a branding area, etc.

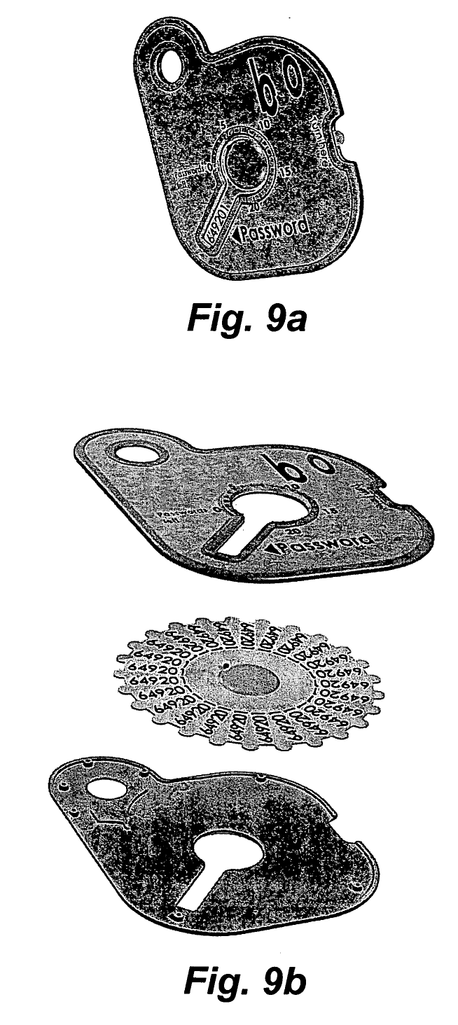

FIG. 9a schematically illustrates an OTP client, according to another embodiment of the invention. FIG. 9b schematically illustrates parts of the OTP client illustrated at FIG. 9a. The major difference between the embodiment illustrated in FIG. 8a and the embodiment illustrated in FIG. 9a is that whilst the embodiment of FIG. 8a has a form factor of a credit card, the embodiment of FIG. 9a has the form factor of a key fob.

Preferably, in the embodiment illustrated in FIGS. 8a and 9a the wheel on which the OTP values are impressed rotates only in one direction in order to prevent trying using the same OTP value more than once.

According to a preferred embodiment of the present invention an OTP system comprises:

An OTP server, such as an authentication server, which provides a service to a user upon authenticating the user by OTP values provided by the user. The server has input means, through which the user can input the OTP values to the server. The input means may be a keyboard, a virtual keyboard, etc.
An OTP client in the form factor of a dispenser, for dispensing a plurality of tickets, each ticket having impressed thereon an OTP value of a sequence which the server is “familiar with”.

The OTP values are arranged in the dispenser in a pre-determined and non-obvious (pseudo-random) order. The relationship between the passwords is extremely difficult to determine, unless one has the particular secret used for generating the OTP values.

According to a preferred embodiment of the invention, each ticket comprises an impression of a sequential number, thereby informing the user thereof of how many tickets remain in the dispenser. The sequential numbers may be either in an increased or a decreased order.

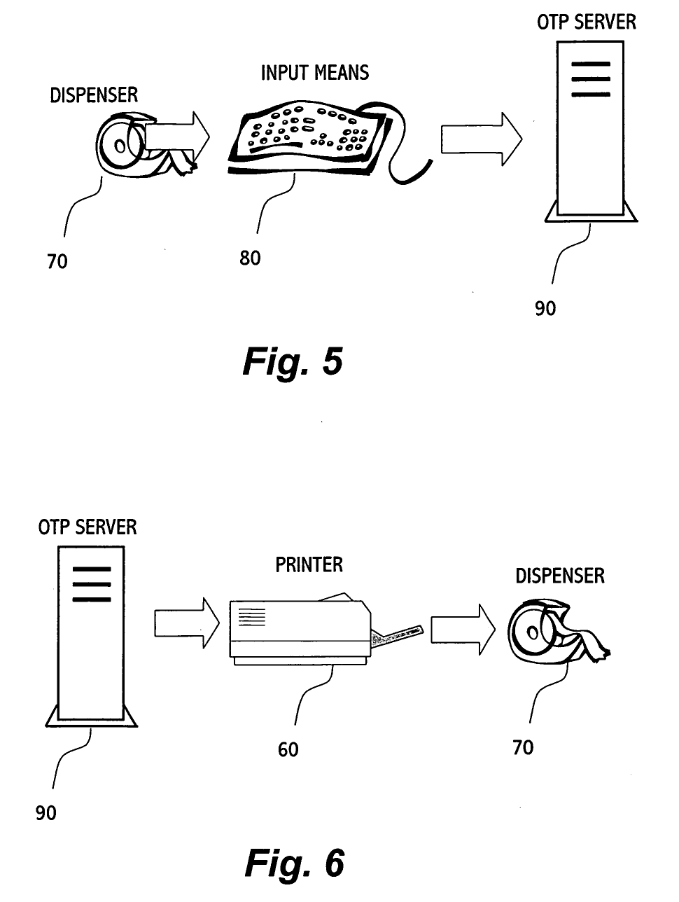

FIG. 5 schematically illustrates an OTP system, according to a preferred embodiment of the invention. The system comprises:
At least one dispenser 70, on which its tickets have impressed a sequence of OTP values, arranged in a pre-determined, non-obvious and deliberate manner. Each OTP value is unique and the relationship between the OTP values is either arbitrary or extremely difficult to determine.
An OTP server 90, to which a user must be authenticated by providing an OTP value from his dispenser.
Input means 80, for inputting an OTP value to the OTP server.

The input means 70 may be a keyboard, a virtual keyboard (e.g., a display on a screen and a mouse with which a user can click on an image of a character instead of typing the character), etc.

According to one embodiment of the invention the OTP values are impressed on the tickets as barcodes. This way, the OTP values may be read in an automated mode by a barcode reader. Barcode is a well known technology in the art, and is known as reliable.

According to another embodiment of the invention, the input means is a scanner operating in coordination with OCR (Optical Character Recognition) mechanism.

Barcode readers and OCR mechanisms are automated mechanisms for inputting OTP values provided by a dispenser. Thus, although OTP dispensers do not have to comprise electronic means, their OTP values still can be read by automated systems.

FIG. 6 schematically illustrates a system for impressing OTP tickets, according to a preferred embodiment of the invention. The system comprises an OTP server 90, for generating a sequence of OTP values; and impression means 60, for impressing generated OTP values of an OTP sequence on tickets. The impression means may be a printer such as text printer, graphic printer, barcode printer, and so forth.

The tickets are assembled in a dispenser 70, and provided this way to a user. The assembly can be carried out separately from the impressing.

The impressed information may be of human readable characters, machine readable characters (e.g., barcode), or both.

According to one embodiment of the invention, the OTP dispenser comprises means for destroying the impression of the OTP values upon attempting to expose the OTP values in a forbidden manner. For example, once a ticket has been exposed, its impression vanishes. According to another embodiment of the invention the impression vanishes as the time goes by, which means that an OTP dispenser can be in force only a limited time. This can be achieved, for example, by thermal paper. As known to a person of ordinary skill in the art, one of the characteristics of thermal paper is that impressions on thermal paper vanish as the time goes by. According to yet another embodiment of the invention, once a dispenser has been assembled, an attempt to disassemble it causes to a liquid stored within the dispenser to be poured on the tickets, and destroy at least their impression.

An OTP dispenser can be used in a one-factor authentication as well as in a multi-factor authentication. A two-factor authentication method employing an OTP dispenser may comprise the following steps:
1) The user inputs to an OTP server an authentication information, such as user identification information (e.g., username), a PIN (Personal Identification Number), which is a number (sequence of characters, in general), etc. This is the first authentication factor.
2) The user obtains from the OTP dispenser a one-time value and provides it to the authentication server (e.g. by typing it on a keyboard connected directly or indirectly to the server). This is the second authentication factor.
3) The OTP server compares the user identification information and the PIN against records in a database. Additionally, the one-time password is compared against a list of valid one-time passwords associated with the user. If a predetermined relationship between the user identification information, PIN and OTP value, is established, then the user is assumed as authenticated.

In some cases an OTP server may require additional algorithms to account for the loss of certain passwords from the sequence of OT values of a dispenser.

Those skilled in the art will appreciate that the invention can be embodied in other forms and ways, without losing the scope of the invention. The embodiments described herein should be considered as illustrative and not restrictive.

1. An OTP client, comprising:
a plurality of tickets, each having an impression of a subsequent OTP value of an OTP sequence; and
a ticket dispenser, for storing said tickets and for dispensing said tickets to a user for an authentication session.

2. An OTP client according to claim 1, further comprising an impression of information for identifying said OTP sequence.

3. An OTP client according to claim 2, wherein said information is a PIN.

4. An OTP client according to claim 1, further comprising an extracting mechanism, for extracting a ticket from said dispenser.

5. An OTP client according to claim 4, wherein said extracting mechanism includes an aperture on a facet of said dispenser.

6. An OTP client according to claim 1, further comprising an amount indication mechanism, for indicating the number of tickets remaining in said dispenser.

7. An OTP client according to claim 6, wherein said amount indication mechanism includes an aperture in the body of said dispenser.

8. An OTP client according to claim 6, wherein said amount indication mechanism includes a sequential number.

9. An OTP client according to claim 1, wherein the impression of OTP value includes an impression of a barcode notation.

10. An OTP client according to claim 1, wherein said OTP value is presented by at least one character.

11. An OTP client according to claim 1, further comprising an attaching mechanism, for attaching said OTP client to a key holder.

12. An OTP client according to claim 1, wherein said ticket dispenser comprises:
a container for storing said tickets;
one or more elastic members, for pushing said tickets to a facet of said container; and
an aperture at said facet, for enabling a finger of a user to dispense said ticket.

13. An OTP system, comprising:
an OTP server, for authenticating a user;
an input device, for inputting an OTP value by said user to said OTP server;
one or more OTP clients, each client comprising:
a plurality of tickets, each having an impression of a subsequent value of an OTP sequence; and
a ticket dispenser, for storing said tickets and for dispensing said tickets to said user in an authentication session.

14. An OTP system according to claim 13, wherein said input device is selected from a group comprising: a keyboard, a virtual keyboard, a barcode reader.

15. A system for producing OTP tickets, the system comprising:
a generation mechanism, for generating a sequence of OTP values; and
an impression mechanism, for impressing said sequence of OTP values on said tickets.

16. A system for producing OTP tickets according to claim 15, wherein said generation mechanism is based on generating random or pseudo-random numbers.

17. A system according to claim 15, wherein said impression mechanism is selected from a group comprising: a printer, a text printer, a graphic printer, a barcode printer.

18. A method for authenticating a user by an OTP server, the method comprising the steps of:
providing to said user a plurality of tickets, each of which having an impression of a subsequent OTP value of an OTP sequence;
providing by said user the OTP value impressed on the first of said tickets to said server;
authenticating said user by comparing the information provided by said user to said system with information expected to be provided by said user to said system.

19. A method for authenticating a user according to claim 18, further comprising: providing by said user additional information to said server.

20. A method for authenticating a user according to claim 19, wherein said additional information is of a multi-factor authentication nature.

21. A method for authenticating a user according to claim 19, wherein said additional information is a PIN.

22. A method according to claim 18, wherein said plurality of tickets is provided in a dispenser.

23. An OTP client, comprising:
at least one display surface on which a plurality of subsequent OTP values of an OTP sequence are impressed;
a housing, for housing said at least one display surface; and
an exposure mechanism, for exposing the next subsequent OTP value of said OTP values that is impressed on said display surface to a user.

24. An OTP client according to claim 23, further comprising an impression of information for relating a value of said OTP sequence to a corresponding OTP sequence.

25. An OTP client according to claim 24, wherein said information is a PIN.

26. An OTP client according to claim 23, further comprising indication mechanism, for indicating the number of unused or used OTP values in said OTP client.

27. An OTP client according to claim 23, further comprising attaching mechanism, for attaching said OTP client to another device.

28. An OTP client according to claim 23, wherein said at least one display surface is provided on a ticket.

29. An OTP client according to claim 23, wherein said display surface is rotational.

30. An OTP client according to claim 23, wherein said housing includes a box.

31. An OTP client according to claim 23, wherein said housing has a form factor of a credit card.

32. An OTP client according to claim 23, further comprising a supplementary mechanism, for performing a supplemental functionality in conjunction with the original functionality of said OTP client but without modifying the original operation of said OTP client.

33. An OTP client according to claim 32, wherein said supplementary mechanism is selected from a group comprising: a smartcard chip, a magnetic stripe, a figure, a branding area, a proximity coil.

34. An OTP client according to claim 23, further comprising a destruction mechanism, for destroying the impression of the OTP values under certain circumstances.
